(19) United States
(12) Patent Application Publication
(10) Pub. No.: US 2016/0072579 A1
(43) Pub. Date: Mar. 10, 2016

(54) A SYSTEM AND A METHOD FOR GENERATING INFORMATION INDICATIVE OF AN IMPAIRMENT OF AN OPTICAL SIGNAL

(71) Applicant: THE UNIVERSITY OF SYDNEY, Sydney, New South Wales (AU)

(72) Inventor: Jochen Schroeder, Sydney, New South Wales (AU)

(21) Appl. No.: 14/787,387

(22) PCT Filed: Apr. 9, 2014
(86) PCT No.: PCT/AU2014/000385

§ 371 Date: Oct. 27, 2015

(30) Foreign Application Priority Data
May 1, 2013 (AU) 2013901515

(51) Int. Cl. H04B 10/079

(52) U.S. Cl. CPC H04B 10/07953; H04B 10/0793

(57) ABSTRACT

A method for generating information indicative of an impairment of an optical signal, such as a decrease in the OSNR is disclosed. The OSNR may be measured without interpolating out of band noise to in-band noise. Consequently, the optical OSNR of the optical signal after propagating through a reconfigurable network may be determined. The method comprises the step of establishing a spectral model of the optical signal within the optical signal's frequency band, the spectral model comprising a spectral impairment profile added to a model spectrum of the optical signal before the impairment, measuring the spectrum of the optical signal to generate in-band optical signal spectrum information indicative of the spectrum of the optical signal within the optical signal's band and determining at least one value of the spectral impairment profile by applying the spectral model of the optical signal to the in-band optical signal spectrum information.

### TECHNICAL FIELD

The disclosure herein generally relates to a system and a method for generating information indicative of an impairment of an optical signal.

### BACKGROUND

An optical signal in a communication network may be impaired by, for example, amplified spontaneous emission from an optical amplifier within the communication network. A key performance indicator of the quality of the signal is the signal to noise ratio. It is possible to monitor a signal to noise ratio by converting an optical signal into an electrical signal and then analysing the electrical signal. This may, however, introduce a significant amount of expensive and energy consuming electronic equipment, which may generally not be a viable approach. Consequently, measuring the optical signal to noise ratio (OSNR) may be generally a more desirable approach.

One prior art technique of measuring OSNR in the optical domain is to measure the optical spectrum of the optical signal on an optical spectrum analyser and divide the peak power within the band with the power between adjacent bands. FIG. 5 illustrates this prior art technique of measuring OSNR by the interpolation of out of band noise (at the two outer x's) to in band noise (at the centre x). The interpolated in band noise is indicated by the horizontal dashed line.

While this technique may be adequate for simple point-to-point networks, it may generally be not applicable for use in wavelength reconfigurable networks. FIG. 6 illustrates the effect of signal routing in wavelength reconfigurable networks, including networks that comprise reconfigurable optical add-drop multiplexers (ROADMs), that may be performed in the optical domain. That is, a specific wavelength band is optically routed through several nodes in the network to the desired endpoint. The filtering history of the in-band signal and the out-of-band noise can be very different, confusing the above mentioned technique. The different in-band noise levels are indicated by horizontal dotted lines.

### SUMMARY

Disclosed herein is a method for generating information indicative of an impairment of an optical signal. The method comprises the step of establishing a spectral model of the optical signal within the optical signal's frequency band. The spectral model comprises a spectral impairment profile added to a model spectrum of the optical signal before the impairment. The method comprises the step of measuring the spectrum of the optical signal to generate in-band optical signal spectrum information indicative of the spectrum of the optical signal within the optical signal's band. The method comprises the step of determining at least one value of the spectral impairment profile by applying the spectral model of the optical signal to the in-band optical signal spectrum information.

The impairment may be, for example, a decrease in the OSNR. Some embodiments of the method may be able to measure, for example, the OSNR without interpolating out of band noise to in band noise. Consequently, the optical OSNR of the optical signal after propagating through a reconfigurable network, for example, may be determined.

In an embodiment, the step of establishing the spectral model of the optical signal within the optical signal's frequency band comprises the step of measuring the spectrum of the optical signal before the impairment. The step of measuring the spectrum of the optical signal before the impairment may comprise the step of measuring the spectrum of the optical signal before the impairment with an optical spectrum analyser.

In an embodiment, the step of measuring the spectrum of the optical signal comprises the step of measuring the spectrum of the optical signal with an optical spectrum analyser.

In an embodiment, the model spectrum comprises a predetermined analytical function.

In an embodiment, the step of applying the spectral model of the optical signal to the in-band optical signal spectrum comprises the step of fitting the spectral impairment profile to the in-band optical signal spectrum information. The step of fitting the spectral impairment profile to the in-band optical signal spectrum information may comprise using a linear regression algorithm.

In an embodiment, the impairment comprises optical noise impairment. The optical noise impairment may be generated, for example, by at least one optical amplifier.

In an embodiment, the spectral impairment profile comprises a spectrally uniform impairment parameter.

Disclosed herein is processor readable tangible media including program instructions which when executed by a processor causes the processor to perform a method disclosed above.

Disclosed herein is a computer program for instructing a processor, which when executed by the processor causes the processor to perform a method disclosed above.

Disclosed herein is a system for generating information indicative of an impairment of an optical signal. The system comprises memory having a spectral model of the optical signal within the optical signal's frequency band, the spectral model comprising a spectral impairment profile added to a model spectrum of the optical signal before the impairment. The system comprises a spectrometer arranged to measure the spectrum of the optical signal to generate in-band optical signal spectrum information indicative of the spectrum of the optical signal within the optical signal's band. The system comprises a spectral impairment determiner arranged to determine at least one value of the spectral impairment profile by applying the spectral model of the optical signal to the in-band optical signal spectrum information.

An embodiment comprises another spectrometer arranged to measure the spectrum of the optical signal before the impairment to establish the spectral model of the optical signal within the optical signal's frequency band. The spectrometer and the other spectrometer may each comprise an optical spectrum analyser.

In an embodiment, the model spectrum comprises a predetermined analytical function.

In an embodiment, the spectral impairment determiner is arranged to fit the spectral impairment profile to the in-band optical signal spectrum information.

In an embodiment, the spectral impairment determiner is arranged to fit the spectral impairment profile to the in-band optical signal spectrum using a regression algorithm.

In an embodiment, the impairment comprises optical noise impairment. The optical noise impairment may be generated, for example, by at least one optical amplifier.

In an embodiment, the spectral impairment profile comprises a spectrally uniform impairment parameter.

Any of the various features of each of the above disclosures, and of the various features of the embodiments described below, can be combined as suitable and desired.

### BRIEF DESCRIPTION OF THE FIGURES

Embodiments will now be described by way of example only with reference to the accompanying figures in which:

FIG. 1 is a schematic diagram of an embodiment of a system for generating information indicative of the impairment of an optical signal.

FIG. 2 shows another embodiment of a system for generating information indicative of the impairment of an optical signal.

FIG. 3 shows a schematic diagram of an architecture of a processor.

FIG. 4 shows a flow diagram of an embodiment of a method for generating information indicative of an impairment of an optical signal.

FIG. 5 illustrates this prior art technique of measuring OSNR.

FIG. 6 illustrates the effect of signal routing in wavelength reconfigurable networks.

FIG. 7 shows a curve, concave down, that is indicative of a model spectrum.

FIG. 8 shows a spectral model without added spectral impairment profiles, and with two example spectral impairment models of FIG. 7.

### DESCRIPTION OF EMBODIMENTS

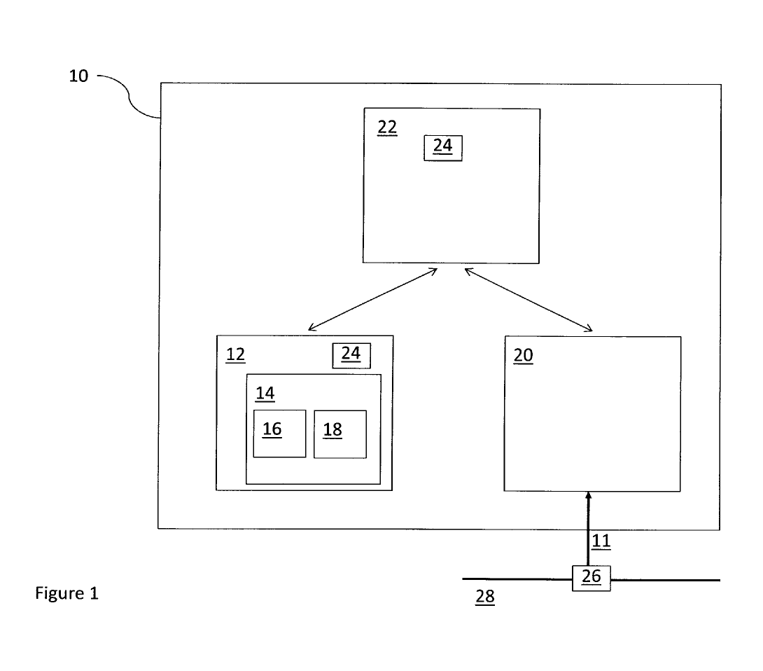

FIG. 1 is a schematic diagram of an embodiment of a system for generating information indicative of the impairment of an optical signal 11, the system being generally indicated by the numeral 10.

The optical signal 11 may be a sample of an optical communication carried by an optical fibre 28 extracted using, for example, a fibre coupler 26, wavelength divisional multiplexer, or generally any suitable device.

The system comprises a spectrometer 20 in the form of an optical spectrum analyser arranged to measure the spectrum of the optical signal 11 to generate in-band optical signal spectrum information indicative of the spectrum of the optical signal 11 within the optical signal's band. The spectrometer may take any other suitable form, for example a plurality of pass band filters coupled to respective optical detectors. In an alternative embodiment, there are only two pass band filters coupled to two optical detectors. Consequently, the measurement in this alternative embodiment is simply a two point measurement at 2 wavelengths. Measurements, however, may be taken at more than two wavelengths.

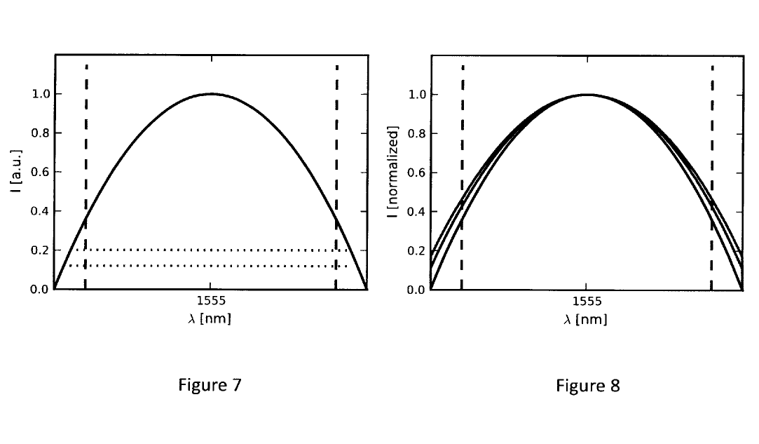

The system comprises memory 12 having a spectral model 14 of the optical signal 11 within the optical signal's frequency band. The spectral model 14 has a spectral impairment profile 16 added to a model spectrum 18 of the optical signal 11 before the impairment. FIG. 7 shows a curve, concave down, around 1555 nm that is indicative of a model spectrum, and two horizontal dotted lines that are indicative of two examples of spectral impairment profiles. In this but not necessarily all examples, the in band noise at the centre of a channel is approximately constant. In this but not necessarily all embodiments the curve is a parabaloid. The band of the optical signal (“In band”) is delimited by the two vertical dashed lines. FIG. 8 shows the spectral model without added spectral impairment profile (bottom most curve), and with the two example spectral impairment profiles of FIG. 7.

The system comprises a spectral impairment determiner 22. The spectral impairment determiner, at least in this embodiment is arranged to cooperate with the memory 12 and the spectrometer 20. The spectral impairment determiner is arranged to determine at least one value of the spectral impairment profile 24 by applying the spectral model of the optical signal to the measured in-band optical signal spectrum. The at least one value of the spectral impairment profile 24 may be communicated to the memory 12 for subsequent retrieval as required.

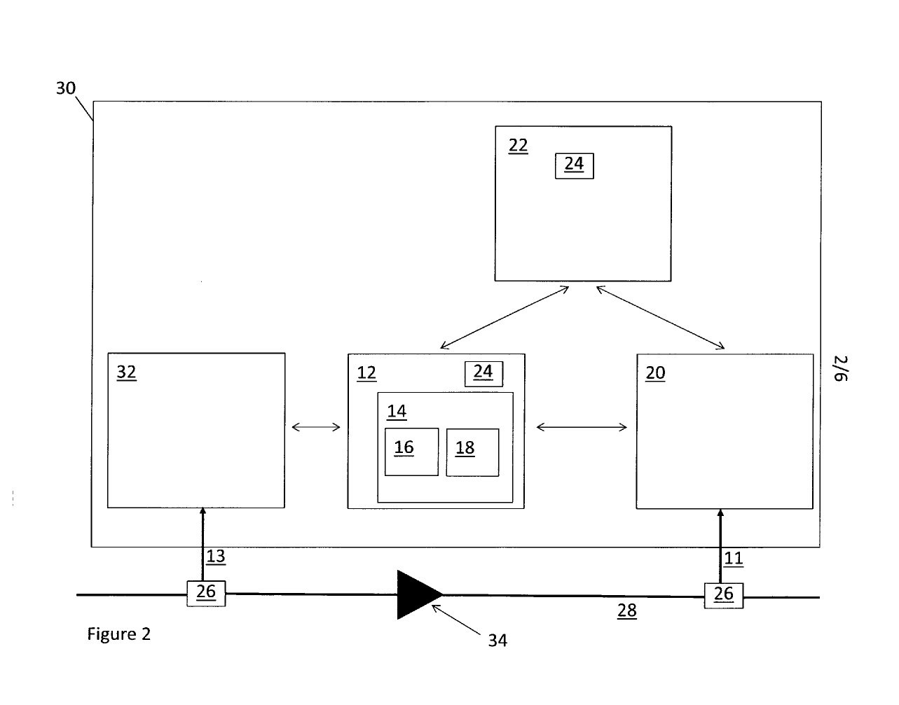

In this but not necessarily all embodiments, the impairment is optical noise impairment. The optical noise impairment may be generated, for example, by at least one optical amplifier. Other types of impairment may be present (for example, nonlinear impairment from nonlinear optical effects), however, they may be sufficiently small to ignore. In other embodiments, other types of impairment may be determined by the system of FIGS. 1 and 2.

The optical signal-to-noise ratio (OSNR) of the optical signal may be determined once the information indicative of the optical noise impairment is generated. For example, if the noise is spectrally uniform in band, then simply dividing the signal's 11 peak power density with the determined noise power density will give the OSNR.

The shape of a normalised spectrum of the signal under test at any point later in a network may depend on the amount of noise that is added during its propagation. From the change in shape of the spectrum, it is generally possible to use embodiments described herein to deduce the OSNR of the signal under test.

FIG. 2 shows another embodiment of a system 30 for generating information indicative of the impairment of an optical signal 11, where parts similar in form and/or function to those of FIG. 1 are similarly numbered. System 30 has another spectrometer 32 arranged to measure the spectrum of the optical signal 13 before the impairment, which in this example is amplified spontaneous emission added to the optical fibre and optical communication thereon by an optical amplifier 34. The measurement is used to establish the spectral model of the optical signal within the optical signal's frequency band. The other spectrometer 32 may comprise an optical spectrum analyser.

In other embodiments, however, there may be no component for the measurement of the optical signal 13 before impairment. The model spectrum 18 may comprise a predetermined analytical function stored in the memory 12. In some embodiments, the spectral impairment determiner 22 is arranged to fit the spectral impairment profile 24 to the in-band optical signal spectrum. The spectral impairment determiner 22 may execute a linear or other suitable regression algorithm.

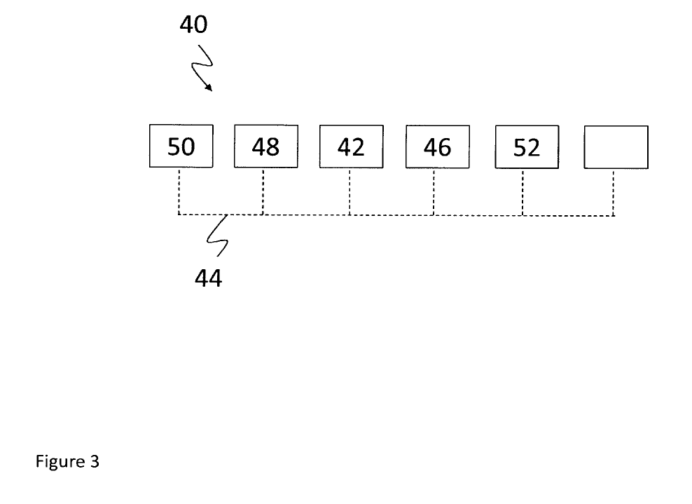

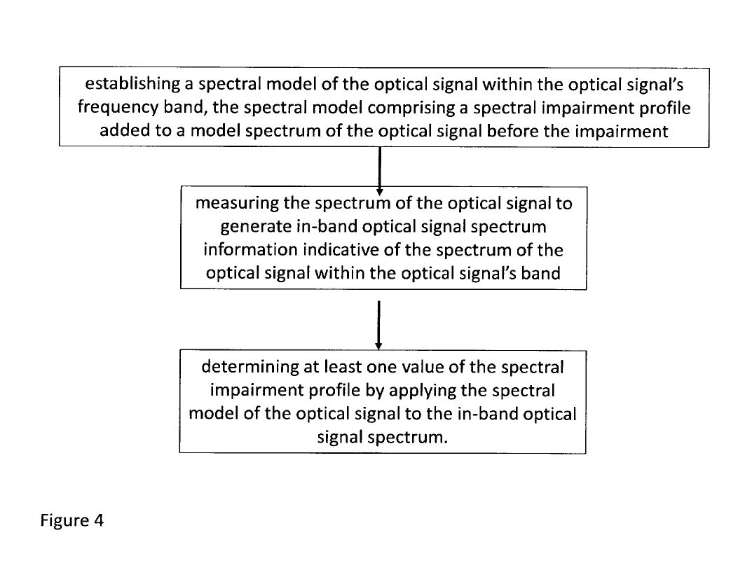

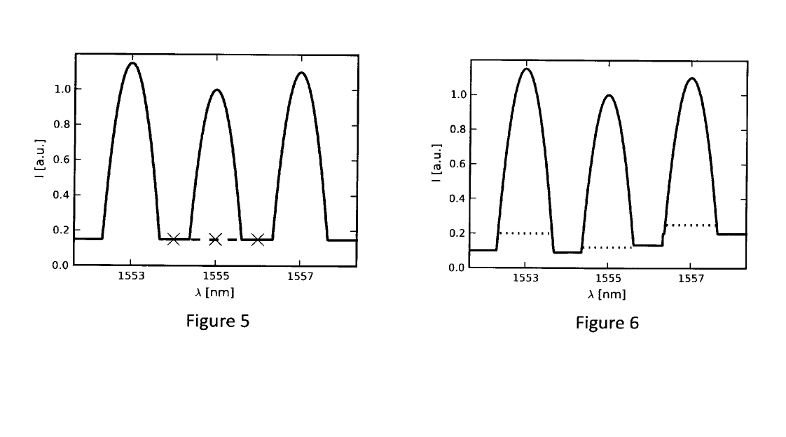

FIG. 3 shows a schematic diagram of the architecture of a processor 40 of the systems 10,30 that may comprise the memory 12 and the determiner 22. The processor can execute the steps of an embodiment of a method for generating information, a flow diagram of which is shown in FIG. 4, for example. The method may be coded in a program for instructing the processor. The program is, in this embodiment stored in nonvolatile memory 48 in the form of a hard disk drive, but could be stored in FLASH, EPROM or any other form of tangible media within or external of the processor. The program generally, but not necessarily, comprises a plurality of software modules that cooperate when installed on the processor so that the steps of the method of FIG. 4 is performed. The software modules, at least in part, correspond to the steps of the method or components of the system described above. The functions or components may be compartmentalised into modules or may be fragmented across several software modules. The software modules may be formed using any suitable language, examples of which include C++ and assembly. The program may take the form of an application program interface or any other suitable software structure. The processor 40 includes a suitable micro processor 42 such as, or similar to, the INTEL XEON or AMD OPTERON micro processor connected over a bus 44 to a random access memory 46 (incorporating memory 12) of around 1 GB and a non-volatile memory such as a hard disk drive 48 or solid state non-volatile memory having a capacity of around 1 Gb. Alternative logic devices may be used in place of the microprocessor 42. Examples of suitable alternative logic devices include application-specific integrated circuits, FPGAs, and digital signal processing units. Some of these embodiments may be entirely hardware based for further latency reduction. The processor 40 has input/output interfaces 50 which may include one or more network interfaces, and a universal serial bus. The processor may support a human machine interface 52 e.g. mouse, keyboard, display etc. The spectrometer(s) 20,32 may be in communication with the processor via a USB, PCIe, or generally any suitable interface.

### EXAMPLE 1

A method of determining the OSNR from simple measurements of the optical spectrum may assume different shapes of the spectrum of the optical signal before impairment and the noise spectrum added to it—the noise being in some examples mainly caused by amplified spontaneous emission (ASE) from at least one optical amplifier.

The spectrum of the noise over a relatively narrow-band signal channel (50 or 100 GHz, for example) is approximately constant. Concatenated truncation by network reconfigurable optical add drop multiplexers (ROADMs) may invalidate this approximation at the channel edges, but it may still continue to hold true at the centre of the channel.

Consider that the signal spectrum shape is known, i.e. via a measurement at the transmitter, such that

S₀(λ)=P₀(1−f(λ)).

Here 1−f (λ) is the normalised signal spectrum and P₀ is a constant proportional to the signal power. We can easily see that f(λₘₐₓ)=0, i.e. f vanishes at the maximum spectral power.

The optical spectrum of the signal under test (SUT) at a later point in the network (which includes noise) can then be written as:

$${S}_{SUT} ( λ ) = loss ( P ( 1 - f ( λ ) + \frac{N}{P} ) )$$

where P and N are the signal and noise power respectively.

Because noise is generally additive while all other processes are multiplicative, it is possible to deconvolve the spectrum to recover the amount of noise and therefore the OSNR. The main assumption is that the shape of the spectrum has not changed significantly, e.g. due to nonlinearity (SPM, XPM).

Normalising the spectrum by the maximum spectral power gives:

$$R = \frac{{S}_{SUT} ( λ )}{{S}_{SUT} ( {λ}_{max} )} = \frac{P ( 1 - f ( λ ) + N / P )}{P ( 1 + N / P )}$$

Rearranging results in:

$$\frac{P}{N} = O S N R = \frac{R - 1}{1 - f ( λ ) + R}$$

f(λ) can be recovered from the measurement before the impairment, for example at the transmitter, e.g. in the case of two measurements at λₘₐₓ and λ₁,

$$f ( {λ}_{1} ) = 1 - \frac{{S}_{0} ( {λ}_{1} )}{{S}_{0} ( {λ}_{max} )}$$

Similarly one could approximate f PO by a analytical function and do a linear regression to find the OSNR. Therefore exact knowledge of the signal spectrum is not strictly necessary.

Finally, in the case that the noise spectrum is not constant, it may also be possible to extend the above method to include the noise shape, which could for example be measured by a measurement of the light within the channel without an input signal.

Variations and/or modifications may be made to the embodiments described without departing from the spirit or ambit of the invention. The present embodiments are, therefore, to be considered in all respects as illustrative and not restrictive.

Prior art, if any, described herein is not to be taken as an admission that the prior art forms part of the common general knowledge in any jurisdiction.

In the claims which follow and in the preceding description of the invention, except where the context requires otherwise due to express language or necessary implication, the word “comprise” or variations such as “comprises” or “comprising” is used in an inclusive sense, that is to specify the presence of the stated features but not to preclude the presence or addition of further features in various embodiments of the invention.

1. A method for generating information indicative of an impairment of an optical signal, the method comprising the steps of:
establishing a spectral model of the optical signal within the optical signal's frequency band, the spectral model comprising a spectral impairment profile added to a model spectrum of the optical signal before the impairment;
measuring the spectrum of the optical signal to generate in-band optical signal spectrum information indicative of the spectrum of the optical signal within the optical signal's band; and
determining at least one value of the spectral impairment profile by applying the spectral model of the optical signal to the in-band optical signal spectrum information.

2. The method according to claim 1 wherein the step of establishing the spectral model of the optical signal within the optical signal's frequency band comprises the step of measuring the spectrum of the optical signal before the impairment.

3. The method according to claim 2 wherein the step of measuring the spectrum of the optical signal before the impairment comprises the step of measuring the spectrum of the optical signal before the impairment with an optical spectrum analyser.

4. The method according to claim 1 wherein the step of measuring the spectrum of the optical signal comprises the step of measuring the spectrum of the optical signal with an optical spectrum analyser.

5. The method according to claim 1 wherein the model spectrum comprises a predetermined analytical function.

6. The method according to claim 5 wherein the step of applying the spectral model of the optical signal to the in-band optical signal spectrum comprises the step of fitting the spectral impairment profile to the in-band optical signal spectrum information.

7. The method according to claim 6 wherein the step of fitting the spectral impairment profile to the in-band optical signal spectrum information comprises using a regression algorithm.

8. The method according to claim 1 wherein the at least one value of the spectral impairment profile corresponds to of an optical noise level.

9. The method according to claim 1 wherein the spectral impairment profile comprises a spectrally uniform impairment parameter.

10. A system for generating information indicative of an impairment of an optical signal, the system comprising:
memory having a spectral model of the optical signal within the optical signal's frequency band, the spectral model comprising a spectral impairment profile added to a model spectrum of the optical signal before the impairment;
a spectrometer arranged to measure the spectrum of the optical signal to generate in-band optical signal spectrum information indicative of the spectrum of the optical signal within the optical signal's band; and
a spectral impairment determiner arranged to determine at least one value of the spectral impairment profile by applying the spectral model of the optical signal to the in-band optical signal spectrum information.

11. The system according to claim 10 comprising another spectrometer arranged to measure the spectrum of the optical signal before the impairment to establish the spectral model of the optical signal within the optical signal's frequency band.

12. The system according to claim 11 wherein the spectrometer and the other spectrometer each comprise an optical spectrum analyser.

13. The system according to claim 10 wherein the model spectrum comprises a predetermined analytical function.

14. The system according to claim 10 wherein the spectral impairment determiner is arranged to fit the spectral impairment profile to the in-band optical signal spectrum information.

15. The system according to claim 14 wherein the spectral impairment determiner is arranged to fit the spectral impairment profile to the in-band optical signal spectrum information using a linear regression algorithm.

16. The system according to claim 10 wherein the at least one value of the spectral impairment profile corresponds to of an optical noise level.

17. The system according to claim 10 wherein the spectral impairment profile comprises a spectrally uniform impairment parameter.

18. Processor readable tangible media including program instructions which when executed by a processor causes the processor to perform a method according to claim 1.

19. A non-transitory computer readable medium with instructions stored thereon for instructing a processor, which when executed by the processor causes the processor to perform a method according to claim 1.
